(19) United States
(12) Patent Application Publication
(10) Pub. No.: US 2008/0208453 A1
(43) Pub. Date: Aug. 28, 2008

(54) NAVIGATION APPARATUS AND ROUTE GUIDANCE METHOD FOR SAME

(76) Inventor: Nobuaki Fujimoto, Iwaki-city (JP)

Correspondence Address: ALPINE/BHGL, P.O. Box 10395, Chicago, IL, 60610, US

(21) Appl. No.: 12/029,996

(22) Filed: Feb. 12, 2008

(30) Foreign Application Priority Data
Feb. 28, 2007 (JP) 2007-048844

(51) Int. Cl. G01C 21/34

(52) U.S. Cl. 701/202

(57) ABSTRACT

The present invention provides a navigation apparatus and a route guidance method that allow a user to easily recognize when a time display is changed based on a difference in time zone or day light saving. Information regarding a plurality of intersections or transit points on a guidance route which are located between a current vehicle position and a destination are displayed in order of proximity to the vehicle. A predicted time of arrival is calculated for each point and displayed in combination with the information. The system then judges whether a time changing point exists between two adjacent points located on the guidance route, and if it is present, the system displays the predicted time of arrival for points located between the time changing point and the destination such that a user can recognize that the predicted time of arrival was changed based on the time change.

### BACKGROUND OF THE INVENTION

The present application claims priority to Japanese Patent Application Number 2007-048844, filed Feb. 28, 2007, the entirety of which is hereby incorporated by reference.

1. Field of the Invention

The present invention relates to a navigation apparatus and a route guidance method. More specifically, the present invention relates to a navigation apparatus and a route guidance method in which information regarding intersections and transit points on a guidance route are displayed along with the predicted time of arrival at the transit points and intersections when guiding a vehicle to a destination.

2. Prior Art

Conventional navigation systems use a display method in which information regarding intersections or transit points located ahead of the vehicle on a guidance route is displayed in combination with a predicted time of arrival for each point. Information regarding the points is then displayed based on the proximity of the points to the vehicle. FIG. 20 illustrates a display method, in which a plurality of points (intersections or transit points) are calculated in order of their proximity to the vehicle position CP on the guidance route GRT (FIG. 20(A)). The names of the points, the distance to the points, the predicted time of arrival at the points, and advancing direction information are obtained to create a maneuver list, which is then displayed in order of the proximity of the points to the vehicle, as shown in FIG. 20(B).

In conventional maneuver list displays, the predicted time of arrival is generally displayed in local time taking any difference in the time zone into consideration. The maneuver list is generally displayed in daylight saving time. However, arrival time displays in conventional maneuver lists are not designed to allow a user to easily recognize when a displayed time has changed based on a time zone or daylight saving time. For this reason, users may become confused when the predicted time of arrival is increased/decreased by ±1 hour due to a change in time zone (time zone change) or when the predicted time of arrival increased/decreased by ±1 hour based on the start or end of daylight saving time.

FIG. 21 is an example of a maneuver list display in the case where different time zones are present. In this example, four transit points P1 to P4 are present between a starting point Pst and a destination point Pds, and a time zone changing point Ptc is present between the transit points P2 to P3 as shown in FIG. 21(A). Note that the maneuver list display also displays an intersection present on a guidance route (not shown). In the case where the time zone changing point is +1 hour, the predicted time of arrival at the transit point P3 is 9:06, despite the fact that the actual traveling distance from transit point P2 is only 10 km, as shown in FIG. 21(B). Thus, conventional navigation systems make it appear that it will take 1 hour and 6 minutes to travel from transit point P2 to P3 because the actual travel time of 6 minutes is added to the 1 hour time difference. However, it is not immediately apparent to the user (driver) that the predicted arrival time is calculated based on the difference in time zone, thus causing the driver to become confused. On the other hand, in the case where the time zone changing point is −1 hour, the predicted time of arrival at the transit point P3 is calculated to be 7:06, as shown in FIG. 21(C). In this case, the predicted time of arrival at transit point P3 appears to be earlier than the predicted arrival time of 8:00 for P2, which is actually closer in proximity to the vehicle than transit point P3. This is because the predicted time of arrival for transit point P3 of 8:06 was calculated using the actual travel time of 6 minutes and the difference in time zone of −1 hour. However, the user cannot immediately understand that the predicted arrival time for transit point P3 is based on the difference in time zones, which causes the user (driver) to become confused.

FIG. 22 is an example of a maneuver list display in the case of crossing a daylight saving time change point while traveling along the guidance route. In this example, four transit points P1 to P4 are present between the starting point Pst and the destination point Pds, and the daylight saving time change point is the point Psm located between the transit points P2 to P3, as shown in FIG. 22(A). Note that the maneuver list display may also display intersections present on a guidance route (not shown). In the case where the predicted arrival time moves forward by +1 hour based on the start of daylight saving time, the predicted times of arrival at the transit points P2 and P3 are 1:56 and 3:06, despite a travel distance of only 10 km. As shown in FIG. 22(B), the travel time from transit point P2 to transit point P3 appears to take as much as 1 hour 10 minutes because the actual travel time of 10 minutes is added to the difference in time zone of 1 hour due to the start of daylight saving time. However, the user cannot immediately understand that the predicted arrival time is based on the start of daylight saving time: which causes the user (driver) to become confused. On the other hand, in the case where the predicted arrival time is delayed by −1 hour based on the end of daylight saving time, the predicted time of arrival at the transit point P3 becomes 1:06, as shown in FIG. 22(C), which is earlier than the predicted arrival time of 1:56 for the transit point P2. This is because the predicted arrival time for transit point P3 is calculated by adding the actual travel time of 10 minutes and the difference in time zone of −1 hour. However, the user cannot immediately understand that the predicted arrival time is based on the end of daylight saving time and the user becomes confused.

Japanese Patent Laid-Open Patent Application No. 226302/2004 describes a navigation apparatus that displays the time of a starting point and a destination by the local time in each time zone in the case where a guidance route passes through a time zone changing point, Further, Japanese Patent Laid-Open Patent Application No. 062383/2002 describes a time display unit that displays time corresponding to a zone in which the vehicle is currently located in the case where two time zones are present in the state/province where the vehicle is traveling.

### SUMMARY OF THE INVENTION

The conventional navigation systems described above do not allow a user to easily understand when the time display of a maneuver list is changed based on a difference in time zones. Furthers conventional systems do not allow the user to easily understand when the time display on a maneuver list is changed based on the start or end of daylight saving time.

Therefore, it is an object of the present invention to allow the user to easily understand when the time display in a maneuver list is changed based on a difference in time zones or daylight saving time.
Route guidance method

A first aspect of an embodiment of the present invention is a route guidance method of a navigation apparatus that guides a vehicle to a destination along a guidance route. The navigation apparatus displays information on intersections or transit points located ahead of a vehicle's position on the guidance route in order of proximity to the vehicle, along with the predicted arrival time at each point. The apparatus then judges whether a time zone changing point is present between two adjacent points, and if the changing point is present, the apparatus displays the predicted time of arrival at the transit point or intersection located ahead of the vehicle position on the guidance route in a manner that allows a user to understand that the arrival time was changed based on a difference in the time zone.

The apparatus also determines whether the arrival time should be advanced by a predetermined amount of time or if the time should be delayed by a predetermined amount of time based on the time zone difference. Time is then displayed in a manner that that allows a user to understand that the predicted time of arrival was advanced by the predetermined amount of time or delayed by the predetermined amount of time based on the difference in the time zone.

Moreover, the apparatus may search for a guidance route to a destination and a time zone changing point on the guidance route in order to generate guidance route information. A plurality of points (transit points and/or intersections) are then displayed using the guidance route information along with a predicted time of arrival for each point. The apparatus then judges whether a time zone changing point is present between two adjacent points on the guidance route using the guidance route information.

In another aspect, a navigation apparatus guides a vehicle to a destination along a guidance route. Initially, information for a plurality of intersections or transit points (points) on the guidance route that are located ahead of a vehicle position is displayed in order of proximity to the vehicle. The predicted time of arrival at each point is then displayed in combination with the information for the point, and the apparatus judges whether daylight saving time will start or end while the vehicle is traveling between the two adjacent points. If the daylight saving time will start or end while the vehicle is traveling between the two adjacent points, the predicted time of arrival at the points located ahead of the vehicle position on the guidance route are displayed in a manner that allows the user to recognize that the time was changed based on the start or end of daylight saving time.

The route guidance method determines whether the arrival time for the points should be advanced by a predetermined amount of time or delayed by a predetermined amount of time based on the start or end of daylight saving time, The predicted time of arrival is then displayed in a manner that allows the user to recognize whether the time was advanced by the predetermined amount of time or delayed by the, predetermined amount of time based on the start or end of daylight saving time.

In yet another aspect, a route guidance method of a navigation apparatus searches for a guidance route passing through transit points in order to reach a destination, and time zone changing points on the guidance route to create guidance route information. When a user requests that the complete guidance route be displayed, the apparatus displays a guidance route, transit points on the guidance route, and a predicted arrival time at the transit points on a map using the guidance route information. The apparatus then judges whether a time zone changing point is present between any two of the starting, destination, or transit points. If the changing point is present, the predicted time of arrival of a point located between the changing point and the destination is displayed in a manner that allows the user to recognize that the time was changed based on a difference in time zones.

In another aspect, a navigation apparatus searches for a guidance route that passes through transit points to reach a destination in order to generate guidance route information. When a user requests that a complete guidance route be displayed, the apparatus displays a guidance route, transit points on the guidance route, and a predicted time of arrival at the transit points on a map using the guidance route information. The apparatus then judges whether daylight saving time will start or end while the vehicle is traveling between any two adjacent points, including the starting point, the destination point, and transit points. If the daylight saving time starts or ends while the vehicle is traveling between two adjacent points, the apparatus displays the predicted time of arrival at a point located farther along the guidance route in a manner that a user can recognize that the time was changed based on the start or end of daylight saving time.
Navigation apparatus

In yet another aspect of the present invention, a navigation apparatus configured to guide a vehicle along a guidance route to a destination includes: a guidance: route searching portion that searches for a guidance route to a destination in order to create guidance route information; a guidance route recording portion that records the guidance route information; an image generating portion that extracts a plurality of intersections or transit points that are located ahead of a vehicle position along the guidance route, orders the points based on proximity to the vehicle using the guidance route information, and creates an image for displaying the predicted time of arrival at each point together with information for each extracted point; and an image display portion that displays the created image. The image generating portion checks whether a time zone changing point is present between two extracted points located adjacent to each other on the guidance path. If the changing point is present, the image generating portion creates an image in a manner that allows a user to recognize that the predicted arrival time at a point located between the vehicle position and the destination was changed based on a difference in time zones. The guidance route searching portion simultaneously searches for a guidance route and a time zone changing point on the guidance route in order to create guidance route information, and the image generating portion checks whether a time zone changing point is present between two of the extracted points located adjacent to each other on the guidance path by using the guidance route information. The image generating portion determines whether time should be advanced by a predetermined amount of time or if time should be delayed by a predetermined amount of time based on the time zone, and creates an image in a manner such that a user can recognize whether the predicted time of arrival was advanced by a predetermined amount of time or delayed by a predetermined amount of time based on a difference in the time zones.

In yet another aspect of the present invention, the navigation apparatus includes: a guidance route searching portion that searches for a guidance route to a destination in order to create guidance route information; a guidance route recording portion that records the guidance route information; an image generating portion that extracts a plurality of intersections or transit points that are located ahead of a vehicle position on a guidance route, and orders the points based on proximity to the vehicle position from closest to farthest by using the guidance route information. The image generating portion also creates an image for displaying the predicted time of arrival at each point together with information regarding each of the extracted points.

The navigation apparatus further includes an image display portion that displays the image created by the image generating portion, in which the image generating portion determines whether daylight saving time will start or end while the vehicle is traveling between two of the extracted points that are located adjacent to one another on the guidance path. If the start or end of daylight saving time occurs while the vehicle is traveling between the two points, the image generating portion creates an image in a manner that allows the user to recognize that the predicted time of arrival at a point located farther along the guidance path than the vehicle position was changed based on the start or end of daylight saving time. The image generating portion determines whether time should be advanced by a predetermined amount of time or if time should be delayed by a predetermined amount of time based on the start or end of daylight saving time, and creates an image in a manner that allows the user to recognize that the predicted time of arrival was advanced by the predetermined amount of time or delayed by the predetermined amount of time based on start or end of daylight saving time. The image generating portion also creates an image in a manner that allows the user to recognize that the predicted time of arrival was changed based on the start or end of daylight saving time using a daylight saving time advance mark or a daylight saving time delay mark.

In another aspect of the present invention, a navigation apparatus that guides a vehicle from a starting point to a destination along a guidance route includes: a guidance route searching portion that searches for a guidance route that passes through transit points and reaches a destination, and a time zone changing point on the guidance route in order to generate guidance route information; a guidance route recording portion that records the guidance route information; a guidance route image creating portion that creates a guidance route, transit points on the guidance route, and a predicted time of arrival at the transit points on a map by using the guidance route information when a user requests the display of the complete guidance route; and a display portion that displays the map image by superimposing the guidance route image thereon, in which the guidance route image creating portion checks whether a time zone changing point is present between any two adjacent points including the starting point, destination point, and the transit points. If the changing point is present between two adjacent points, the guidance route image creating portion creates the guidance route image in a manner where the user can recognize that the predicted time of arrival at the point was changed due to a difference in time zones.

In yet another aspect, a navigation apparatus that guides a vehicle from a starting point to a destination along a guidance route includes: a guidance route searching portion that searches for a guidance route that passes through transit points and reaches a destination, and searches for a time zone changing point on the guidance route in order to generate guidance route information; a guidance route recording portion that records the guidance route information; a guidance route image creating portion that creates a guidance route image for recognizably displaying a guidance route, transit points on the guidance route, and a predicted time of arrival at the transit points on a map by using the guidance route information when a user requests the complete guidance route to be displayed; and a display portion that displays the map image by superimposing the guidance route image thereon, in which the guidance route image creating portion determines whether the start or end of daylight saving time will occur while the vehicle is traveling between any two adjacent points including the starting point, the destination, and transit points. If the start or end of daylight saving time occurs while the vehicle is traveling between two points, the image creating portion creates the guidance route image in a manner that allows the user to recognize that the predicted time of arrival at a point between the starting point and the destination on the guidance path was changed based on the start or end of daylight saving time.

### BRIEF DESCRIPTION OF THE DRAWINGS

FIGS. 1(A)-(C) illustrate an example of a first maneuver list display according to an embodiment of the present invention.

FIGS. 2(A)-(C) illustrate another example of the first maneuver list display according to an embodiment of the present invention.

FIGS. 3(A)-(D) illustrate an example of a second maneuver list display according to an embodiment of the present invention.

FIGS. 4(A)-(C) illustrate another example of the second maneuver list display according to an embodiment of the present invention.

FIGS. 5(A)-(B) illustrate an example of a display showing a complete guidance route according to an embodiment of the present invention.

FIGS. 6(A)-(B) illustrate another example of a display showing a complete guidance route according to an embodiment of the present invention.

FIG. 7 illustrates a navigation apparatus according to an embodiment of the present invention.

FIG. 8 illustrates an example of guidance route information.

FIG. 9 illustrates a guidance route explanatory view.

FIG. 10 is a flow chart of a route guidance process according to an embodiment of the present invention.

FIG. 11 is a flow chart of the process of creating and displaying a maneuver list image.

FIG. 12 illustrates an exemplary view of a maneuver list image.

FIGS. 13(A)-(B) illustrate an example of a maneuver list image according to an embodiment of the present invention.

FIG. 14 is a flow chart of a route guidance method according to another embodiment of the present invention.

FIG. 15 is a flow chart of the creation and display processes of a maneuver list image according to an embodiment of the present invention.

FIG. 16 illustrates an exemplary view of the maneuver list image creation process.

FIGS. 17(A)-(B) illustrate. an example of a maneuver list image according to a second embodiment of the present invention.

FIG. 18 is a flow chart of the route guidance process according to an embodiment of the present invention.

FIG. 19 is a flow chart of a complete route display process for advancing or delaying time by 1 hour based on the start or end of daylight saving time.

FIGS. 20(A)-(B) illustrate an exemplary view of a conventional display method in which a plurality of points are displayed in order of proximity to a vehicle position along with the predicted time of arrival at each point.

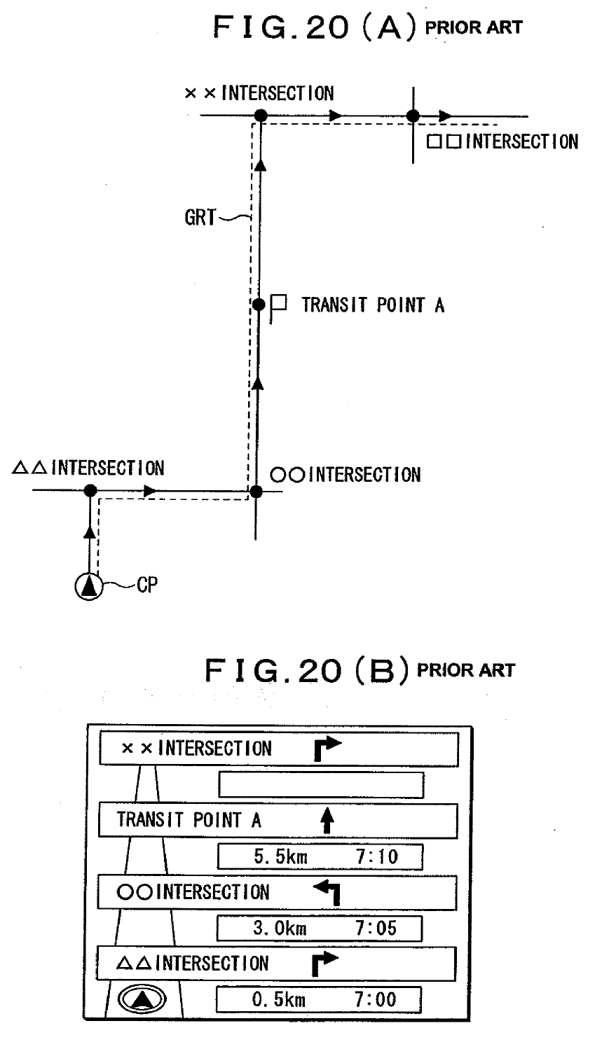

FIGS. 21(A)-(C) illustrate an example of a conventional maneuver list when a time zone change point is present on the guidance route.

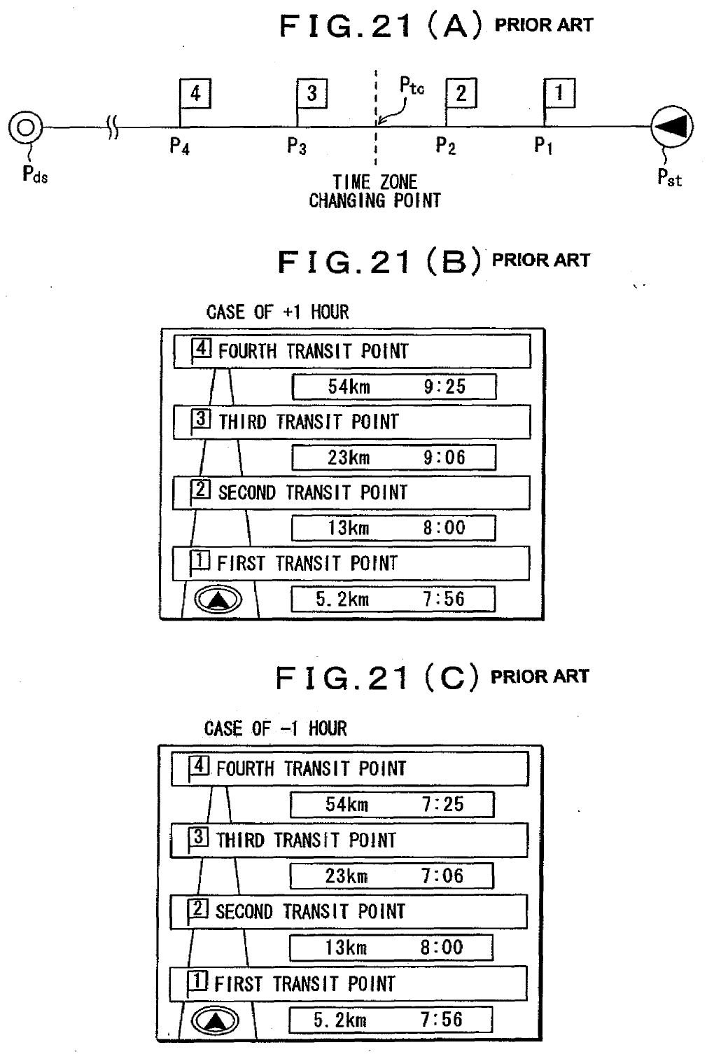

FIGS. 22(A)-(C) illustrate an example of a conventional maneuver list display in the case where the vehicle passes through a daylight saving time change point while traveling along the guidance route.

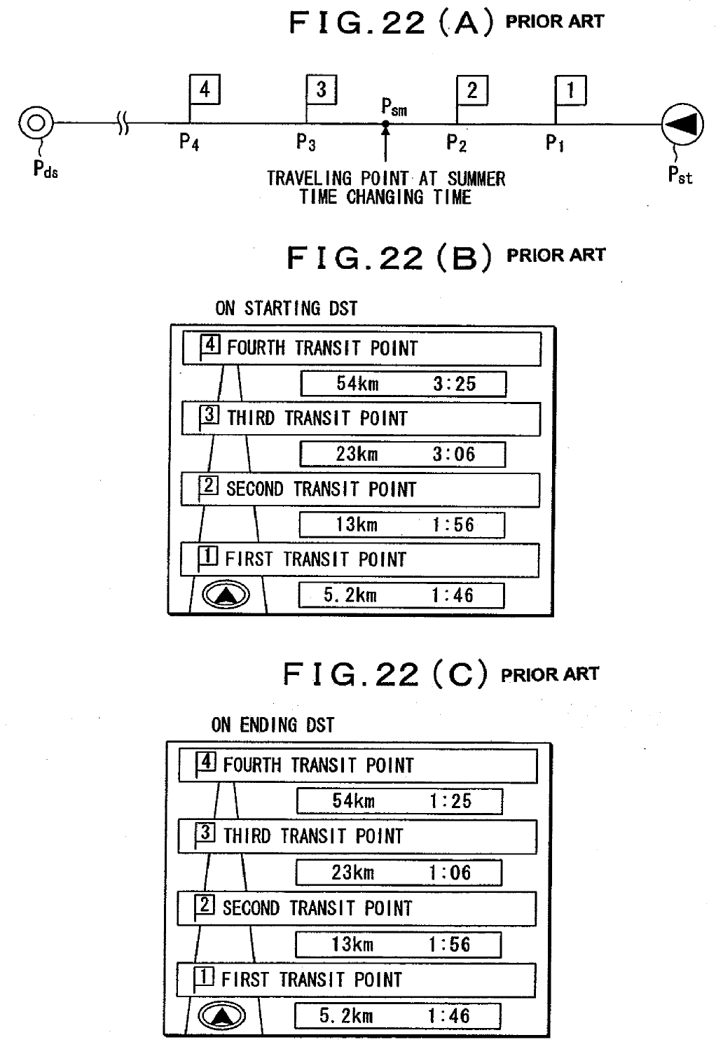

### DESCRIPTION OF THE PREFERRED EMBODIMENTS

(A) Summary of the Present Invention

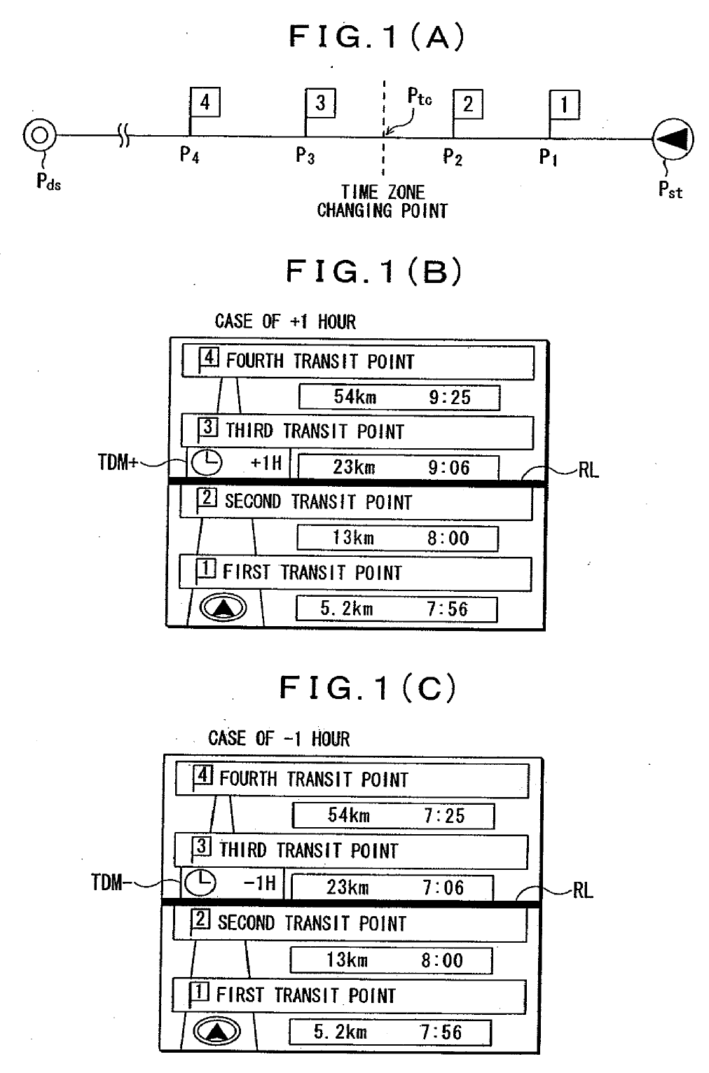

FIGS. 1(A)-(C) illustrate a first maneuver list display example according to an embodiment of the present invention. Four transit points P1 to P4 are present between a starting point Pst and a destination point Pds, and a time zone changing point Ptc is present between the transit points P2 and P3, as shown in FIG. 1(A). Note that the maneuver list display may also display the intersections present on a guidance route (not shown). In the case where the time zone changing point Ptc is +1 hour, the fact that the predicted time of arrival at the transit point P3 was advanced by +1 hour based on a difference in time zones is shown by a time zone mark TDM+, as shown in FIG. 1(B). In the case where the time zone changing point Ptc is −1 hour, the fact that the predicted time of arrival at the transit point P3 was delayed by −1 hour based on a difference in time zones is shown by a time zone mark TDM−, as shown in FIG. 1 (C). Further, the fact that the predicted time of arrival was changed due to a change in time zone is designated by a thick red line RL.

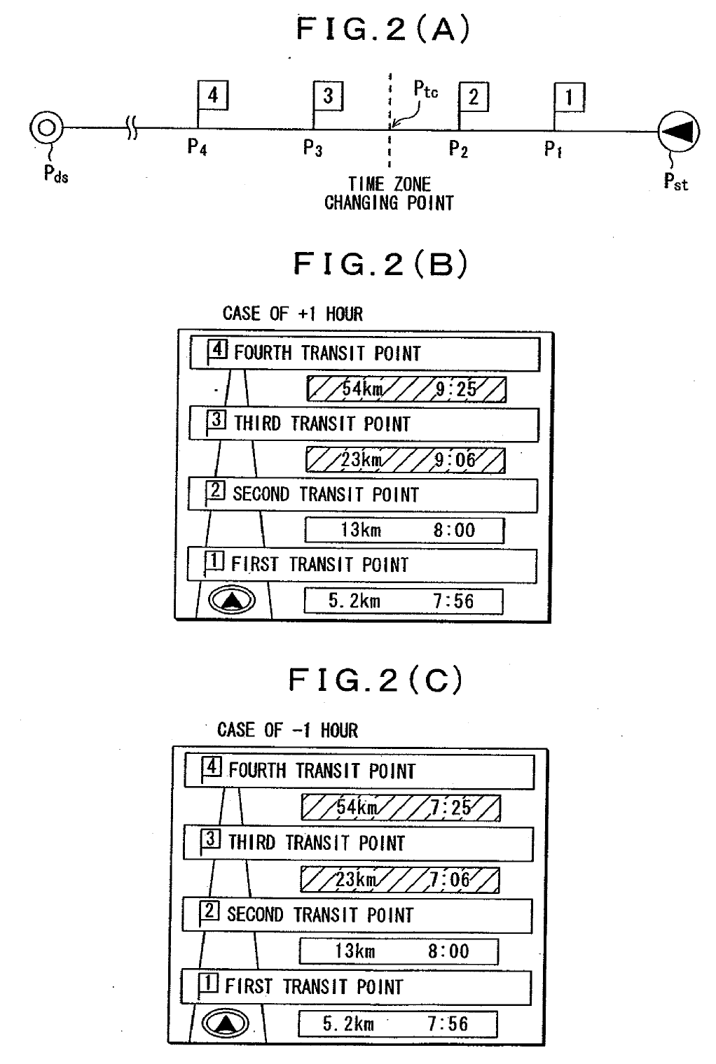

FIGS. 2(A)-(C) illustrate another display example where the display color of the predicted time of arrival (shown in oblique lines) is displayed in a different color from the predicted arrival time for the transit points P1 and P2, which were not affected by the difference in time zones, to distinguish the fact that the arrival times at the transit points P3 and P4 were changed due to a difference in time zones. FIG. 2(B) illustrates the case where the time zone changing point Ptc is +1 hour, and FIG. 2(C) illustrates the case where the time zone changing point Ptc is −1 hour.

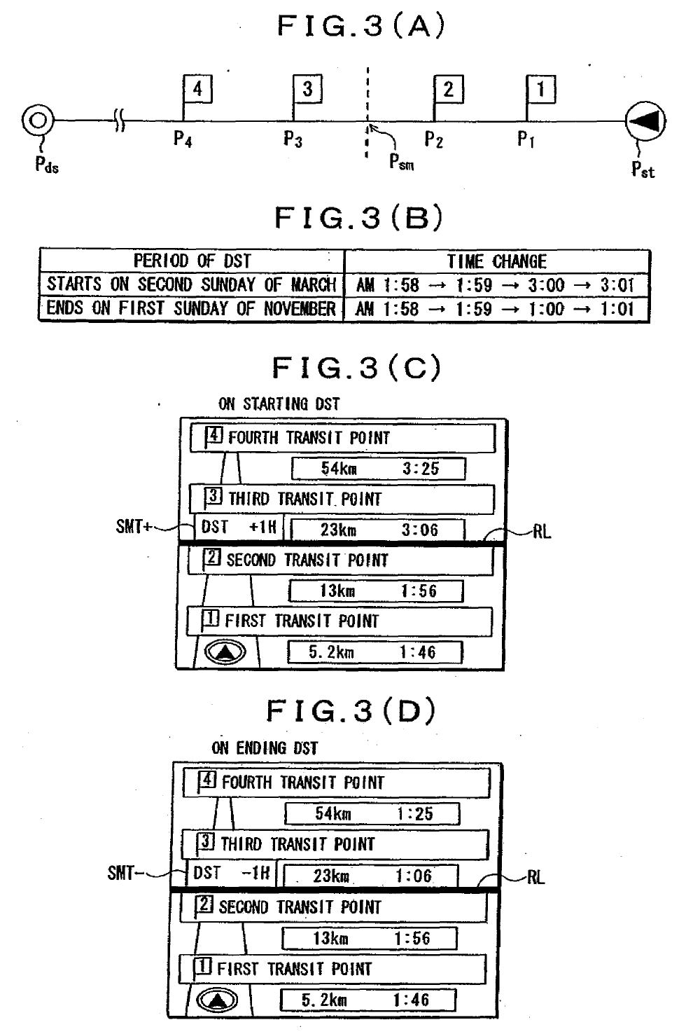

FIGS. 3(A)-(D) illustrate a second example of a maneuver list display according to the present invention. Four transit points P1 to P4 are present between the starting point Pst and the destination point Pds, as shown in FIG. 3(A), and a daylight saving time start/end is shown as a point Psm located between the transit points P2 and P3. Note that the maneuver list display may also display the intersections present on a guidance route (not pictured). In FIG. 3, the daylight saving time start time is 2:00 AM on the second Sunday of March and the end time is 2:00 AM on the first Sunday of November, as shown in FIG. 3(B). While daylight saving time is called Daylight Saving Time (DST) in the U.S., it should be understood that it only differs from European Summer Time in the start and end dates and times.

In the case where time is moved forward by +1 hour based on the start of daylight saving time, the fact that the predicted time of arrival at the transit point P3 is advanced by +1 hour based on the start of daylight saving time is shown by a daylight saving time mark SMT+, as shown in FIG. 3(C). In the case where time is delayed by −1 hour based on the end of daylight saving time, the fact that the predicted time of arrival at the transit point P3 is delayed by −1 hour based on the end of daylight saving time is shown by a daylight saving time mark SMT−, as shown in FIG. 3(D). Furthermore, the fact that the predicted time of arrival was changed based on the start or end of daylight saving time is also shown by the thick red line RL.

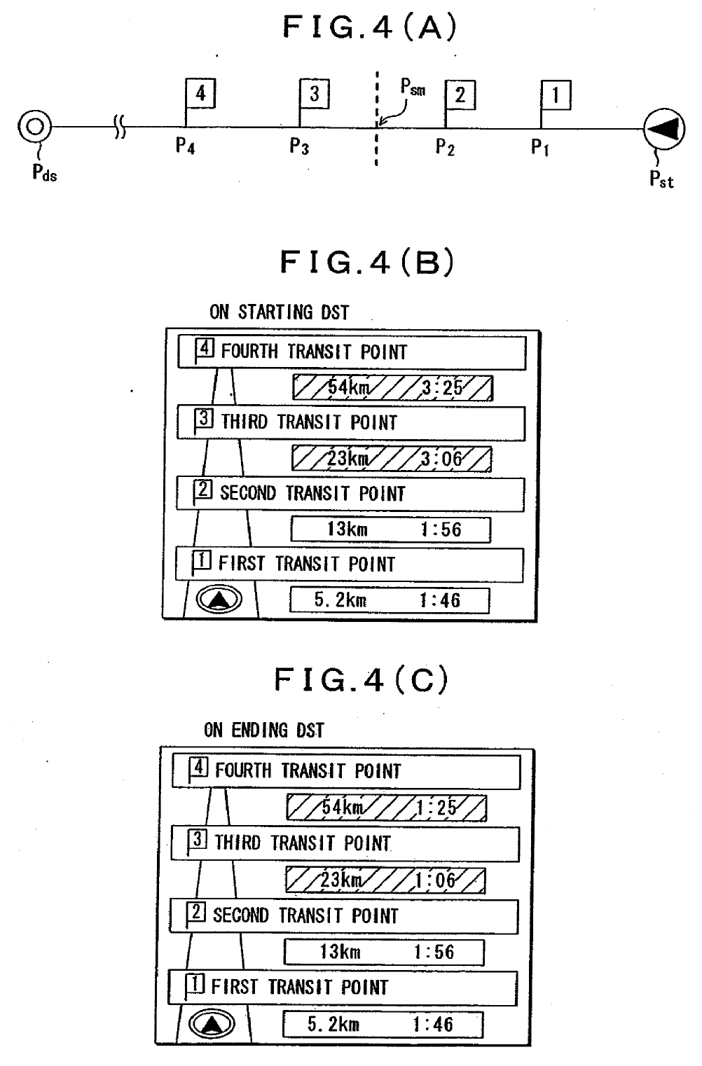

FIGS. 4(A)-(C) illustrate another display example where daylight saving time starts or ends at the point Psm while the vehicle is traveling between the transit points P2 and P3. In this example, the display color of the predicted time of arrival (shown in oblique lines) for the transit points P3 and P4, in which the time of arrival was advanced or delayed based on daylight saving time, is shown in a way that is distinguishable from the display color for the predicted time of arrival at the transit points P1 and P2. FIG. 4(B) illustrates the case where daylight saving time starts at the point Psm (+1 hour), and FIG. 4(C) illustrates the case where daylight saving time ends at the point Psm (−1 hour).

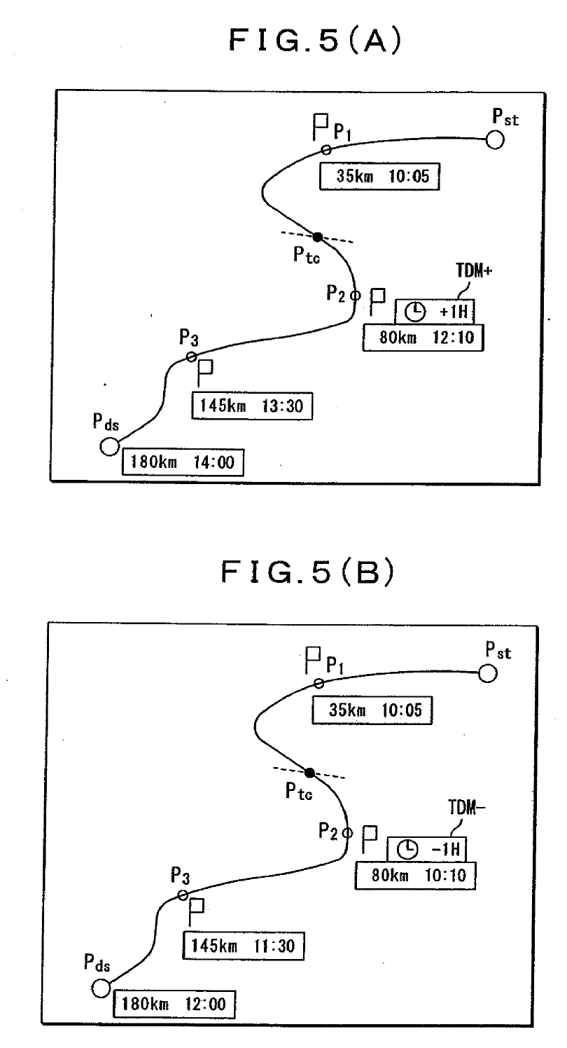

FIGS. 5(A)-(B) illustrate an example of a complete guidance route display according to an embodiment of the present invention. As shown in FIG. 5, three transit points P1 to P3 are present between the starting point Pst and the destination point Pds, and a time zone changing point Ptc is located between the transit points P1 and P2. In the case where the time zone changing point Ptc is +1 hour, the fact that the predicted time of arrival at the transit point P2 was advanced by +1 hour based on the difference in time zones is designated by displaying a time zone mark TDM+, as shown in FIG. 5(A). In the case where the time zone changing point is −1 hour, the fact that the predicted time of arrival at the transit point P2 is delayed by −1 hour based on a difference in time zone is designated by displaying a time zone mark TDM−, as shown in FIG. 5(B).

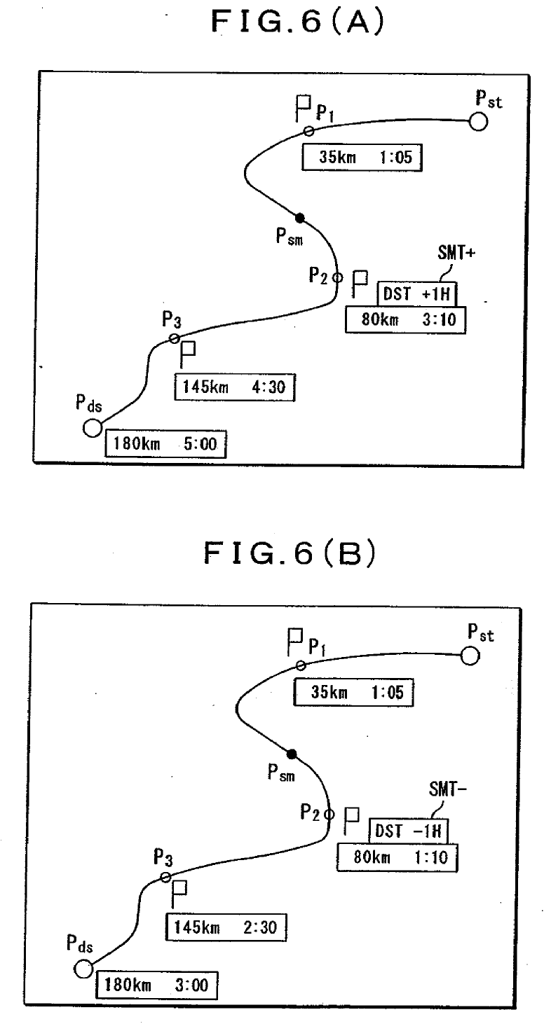

FIGS. 6(A)-(B) illustrate another example of a complete route display according to an embodiment of the present invention. In this example, three transit points P1 to P3 are present between the starting point Pst and the destination point Pds. A daylight saving time start or end time occurs at the point Psm, which is located between the transit points P1 and P2. In the case where time is moved forward by +1 hour based on the start of daylight saving time, the fact that the predicted time of arrival at the transit point P2 was advanced by +1 hour based on the start of daylight saving time is designated by displaying a daylight saving time mark SMT+, as shown in FIG. 6(A). In the case where time is delayed by −1 hour based on the end of daylight saving time, the fact that the predicted time of arrival at the transit point P2 was delayed by 1 hour based on the end of daylight saving time is designated by displaying a daylight saving time mark SMT−, as shown in FIG. 6(B).
(B) Navigation apparatus

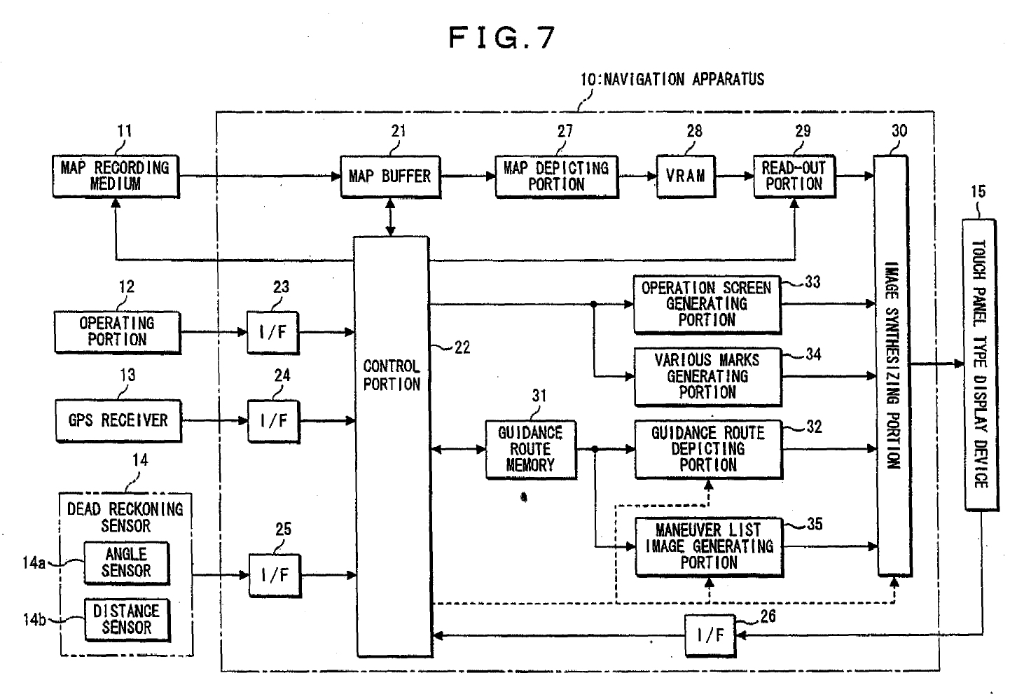

FIG. 7 illustrates a navigation apparatus according to an embodiment of the present invention.

In the navigation apparatus, map data is recorded on a map recording medium (such as CD-ROM, DVD) 11, and designed to be read out when necessary. The map data is constituted by a road layer used to perform a guidance route search or map matching, a background layer for displaying objects on a map, a character layer for displaying characters such as municipality names on a map, and the like. An operating portion 12 is used for operating a navigation apparatus 10, and includes a remote controller and hard keys for operation use and the like,

A GPS receiver 13 receives positional information sent from a GPS satellite to measure the absolute present position of a vehicle. A dead reckoning sensor 14 has an angle sensor 14a, such as a gyro sensor, for detecting a vehicle rotation angle, and a distance sensor 14b that generates a pulse at set intervals. The GPS receiver 13 is capable of estimating the present position of the vehicle autonomously. The navigation apparatus 10 uses the GPS receiver 13 and a dead reckoning sensor 14 in combination, and performs map matching to estimate the current vehicle position.

A touch panel type display unit 15 is configured to display a vehicle peripheral map, a maneuver list, a complete guidance route, other guidance information, and a menu and the like according to the instructions received from the navigation apparatus 10. Further, the touch panel type display unit 15 is designed to input a predetermined command to the navigation apparatus 10 when a soft key displayed on a screen is pressed.

In the navigation apparatus 10, a map buffer 21 records the map data read out from the map recording medium 11. A control portion 22 executes (1) calculation control of the present position of the vehicle, (2) map read-out control where the map data around the vehicle is read out to a map buffer 21, (3) guidance route search control, and (4) map matching control or the like based on various types of information and commands input via the interfaces 23 to 26. In a guidance route search, the control portion 22 searches for a guidance route from a starting point to a destination point and for a time zone changing point located on the guidance route in order to generate guidance route information, The control portion 22 then records the information in a guidance route memory 31. A map depicting portion 27 generates a map image using map data read out from the map buffer 21 and writes the image in a VRAM 28. An image read-out portion 29 cuts out a predetermined image portion from the image written in the VRAM 28 according to an instruction from the control portion 22, and inputs the predetermined image portion to an image synthesizing portion 30.

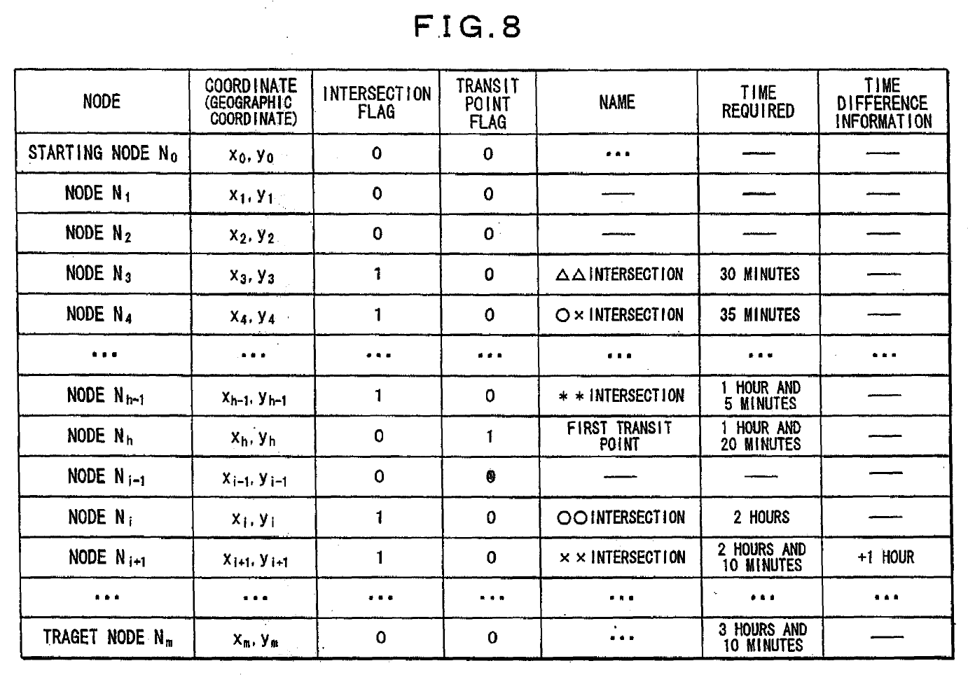

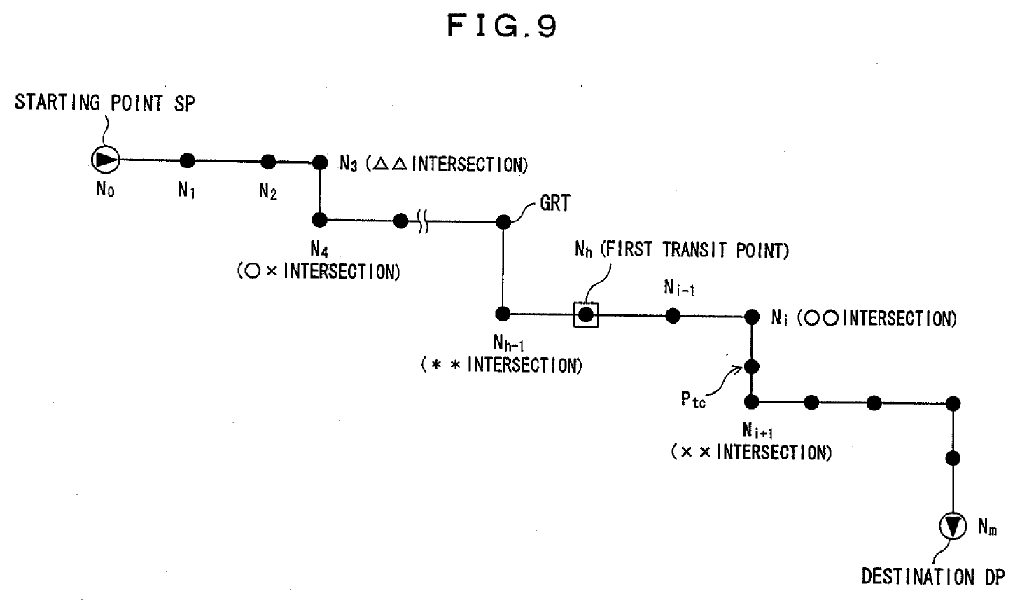

A guidance route memory 31 records guidance route information to a destination searched by the control portion 22. The guidance route information includes positional data for all the nodes constituting the guidance route from the starting point to the destination. FIG. 8 illustrates an example of guidance route information for a guidance route GRT shown in FIG. 9. The guidance route information includes (1) positional data of all the nodes constituting the guidance route GRT, (2) intersection flags showing whether the node is an intersection, (3) transit point flags showing whether the node is a transit point, (4) point names for the intersection/transit point, (5) time required to travel from a starting point to another point, (6) time zone information showing whether a time zone changing point for moving time forward by +1 hour, or a time zone changing point for delaying by −1 hour is present between a previous node and a subject node. Note that, in FIG. 9, a +1 hour time zone changing point Ptc is present between node Ni and node Ni+1.

A guidance route depicting portion 32 generates a guidance route image for input to the image synthesizing portion 30 using the guidance route information recorded in the guidance route memory 31, and highlights the guidance route information on a map displayed on the screen. Further, when a complete route display is requested by the control portion 22, the guidance route depicting portion 32 creates a complete route image from the starting point to the destination point (see FIGS. 5 and 6) by using guidance route information, and displays it on a screen by a control described later.

An operation screen generating portion 33 creates various menu screens (operation screen) which are input to the image synthesizing portion 30, and a mark generating portion 34 creates vehicle position marks and various other marks, such as a cursor, which are input to the image synthesizing portion 30. A maneuver list image generating portion 35 generates the maneuver list image shown in FIG. 1 to FIG. 4, and inputs the maneuver list to the image synthesizing portion 30. The image synthesizing portion 30 superimposes various marks or a guidance route image on a map image read out from the VRAM 28 or the maneuver list image which may be displayed on the entire screen according to instructions received from the control portion 22. Alternatively, a complete route image may be displayed.
(C) First example of route guidance

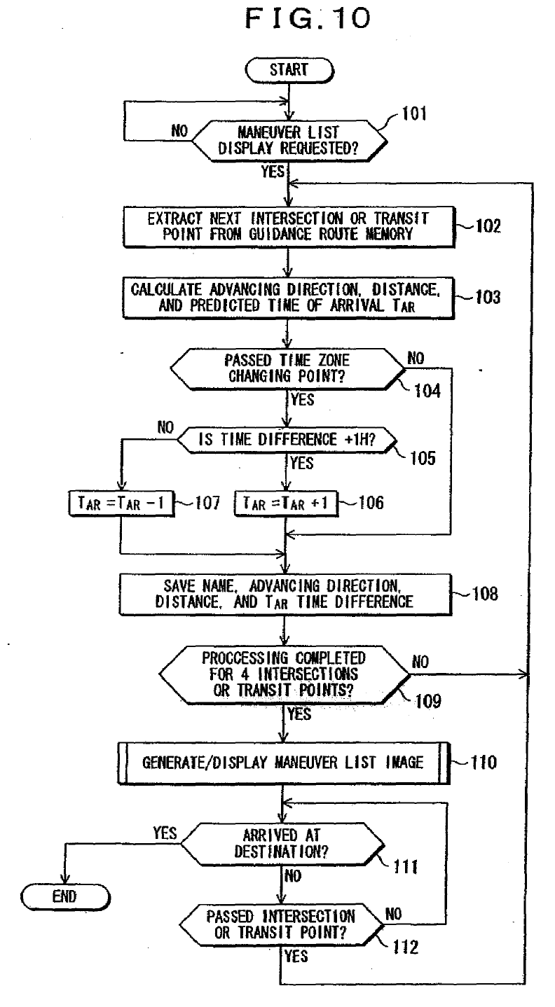

FIG. 10 is a flow chart of an exemplary route guidance process in a case where time is advanced or delayed by 1 hour based on a difference in time zones.

The maneuver list image generating portion 35 monitors whether a maneuver list was instructed from the control portion 22 to be displayed (step 101). When the maneuver list display is requested by a user operation, the control portion 22 instructs the maneuver list image generating portion 35 to display the maneuver list. The maneuver list image generating portion 35 extracts the intersection or transit point located ahead of a vehicle position on the guidance route from the guidance route memory 31 based on an instruction from the control portion 22 (step 102). The maneuver list generating portion 35 then calculates an advancing direction (right/left turn or go straight) for the vehicle at the extracted intersection or transit point, as well as the distance from the vehicle position to the extracted point and a predicted arrival time T_{AR} (step 103). Next, the control portion 22 checks whether the vehicle passes the time zone changing point Ptc before the extracted transit point or intersection (step 104). If the vehicle does not pass through the time zone changing point Ptc before the extracted transit point or intersection, the predicted arrival time T_{AR} is not changed. However, if the vehicle does pass through the time zone changing point Ptc before the extracted transit point or intersection, the control portion 22 checks whether the time zone is +1 hour (step 105). If the time zone is +1 hour the predicted arrival time T_{AR} is advanced by 1 hour based on the equation T_{AR}=T_{AR}+1 (step 106). If the time zone is −1 hour, the predicted arrival time T_{AR} is delayed by 1 hour based on the equation T_{AR}=T_{AR}−1 (step 107).

After the predicted arrival time T_{AR} is calculated, the maneuver list image generating portion 35 records the point name, the vehicle advancing direction, the distance to the point, the predicted arrival time T_{AR}, and the time zone information (step 108). Next, the maneuver list image generating portion 35 checks whether the above-described process has been completed for all the intersections or transit points (in this example there are four intersections and transit points on the guidance route) (step 109). If the process has not been completed for all the intersections and transit points, the process repeats steps S102 to S109 for each remaining intersection or transit point. The extracted point name, the vehicle advancing direction, the distance to the point, and the predicted arrival time T_{AR} of the points located ahead of the vehicle on the guidance route are listed in order of proximity to the vehicle position and displayed in a maneuver list display. It should be understood that a street name where the points are present may be displayed instead of the point name.

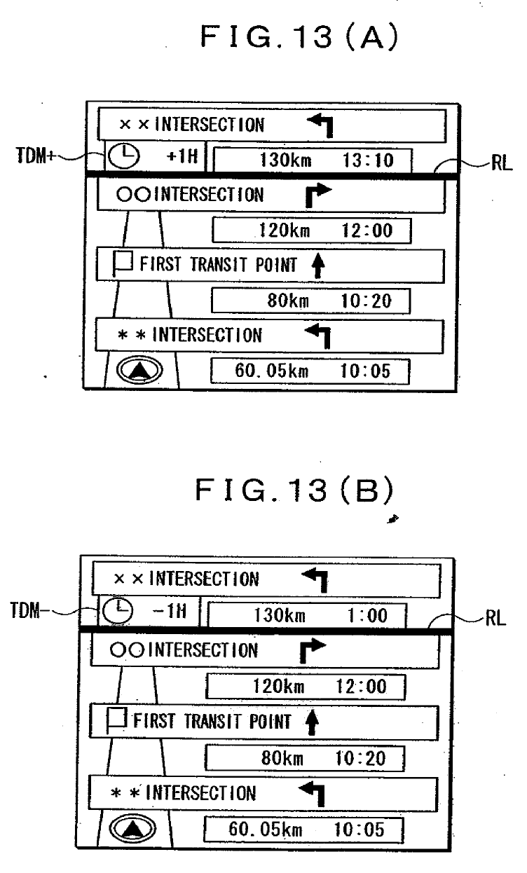

In step 109, when process ends for the four intersections and transit points, the maneuver list image generating portion 35 creates and displays a maneuver list image (step 110). FIGS. 13(A) and (B) illustrate examples of the maneuver list image including a time zone mark.

After the maneuver list image is displayed, the maneuver list image generating portion 35 monitors whether the vehicle has arrived at the destination (step 111). If the vehicle has not arrived at the destination, the maneuver list image generating portion 35 monitors whether the vehicle has passed the next intersection or transit point (step 112), and if so, the process returns to step 102 and steps 102-112 are repeated. Thus, the maneuver list image generating portion 35 constantly creates and displays the maneuver list image including the four points closest to the vehicle position on the guidance path and repeats the above-described process until the vehicle arrives at the destination.

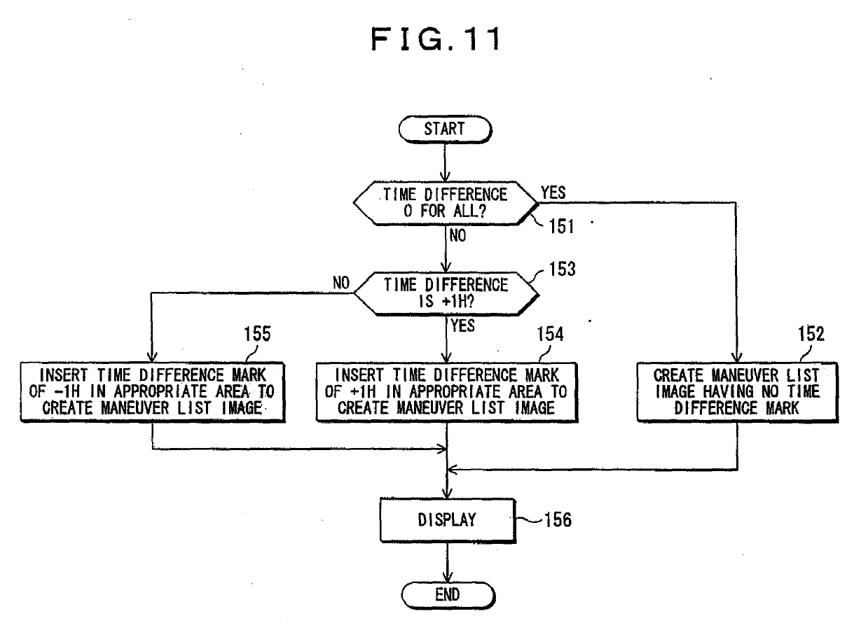

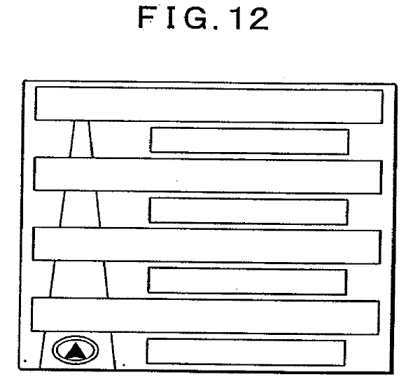

FIG. 11 is a flow chart of the creating and displaying process of the maneuver list image in step 110 of FIG. 10. The maneuver list image generating portion 35 checks whether any time zone information is included in the information for the four points (step 151). If no time zone information is included in the information, the maneuver list image generating portion 35 creates a maneuver list image having no time zone mark (step 152), and the display unit 15 displays the maneuver list image (step 156). The maneuver list image itself is structured as shown in FIG. 12, and may incorporate characters or reference codes showing predetermined information for points in each frame.

If, on the other hand, a +1 hour of time zone information is included in information for one of the four points (step 151), the portion checks whether the time zone difference is +1 hour (step 153), and if so, a +1 hour time zone mark TDM+ is added to an appropriate area of the maneuver list image that is similar to the maneuver list image created in step 152 (step 154). The display unit 15 then displays the maneuver list image (step 156). A red line RL may also be added to the maneuver list image to farther distinguish the points affected by the difference in time zone, as shown in FIG. 13(A). Further, if the time zone difference is −1 hour, a −1 hour time zone mark TDM− is added to an appropriate area of a maneuver list image that is similar to the maneuver list image created in step 152 (step 155), and the display unit 15 displays the maneuver list image (step 156). A red line RL may also be added to the maneuver list image to further distinguish the points affected by the difference in time zone, as shown in FIG. 13(B).

In the above described process, the time zone mark is displayed to show a change in time display based on a difference in time zones, but as shown in FIG. 2, the display color of a predicted time of arrival (shown in oblique lines) at a point affected by a time zone change can be displayed in a manner to distinguish it from the display color of the predicted time of arrival at points that were unaffected by the change in the time zone. Meanwhile, when the predicted time of arrival of all four displayed points become affected by the change in time zones, all the points are displayed in the same color they were displayed in prior to the change in time zones.

As described above, according to the route guidance method of the first example, in the case where a time zone changing point is present between two adjacent points, the predicted time of arrival at a point located farther along the guidance path than the vehicle position is displayed in a manner such that a user can recognize that the time was changed due to a difference in time zones. Thus, the user can easily discern when time is changed based on a change in the time zone. Further, according to the route guidance method of the first example, the user can easily recognize whether time was advanced by a predetermined amount of time or delayed by a predetermined amount of time based on a change in the time zone. Further, according to the present invention, the advance time zone mark (+1 hour time zone mark) or the delay time zone mark (−1 hour time zone mark) is displayed, thus allowing the user to recognize at a glance when the time display is changed based on the time zone. Further, according to the present invention, when the color of the predicted time of arrival at the points affected by the change in time zone is displayed differently from the display color of the predicted time of arrival at points unaffected by the change in time zone, the user can recognize at a glance a change in time display based on a change in the time zone.
(D) Second example of route guidance

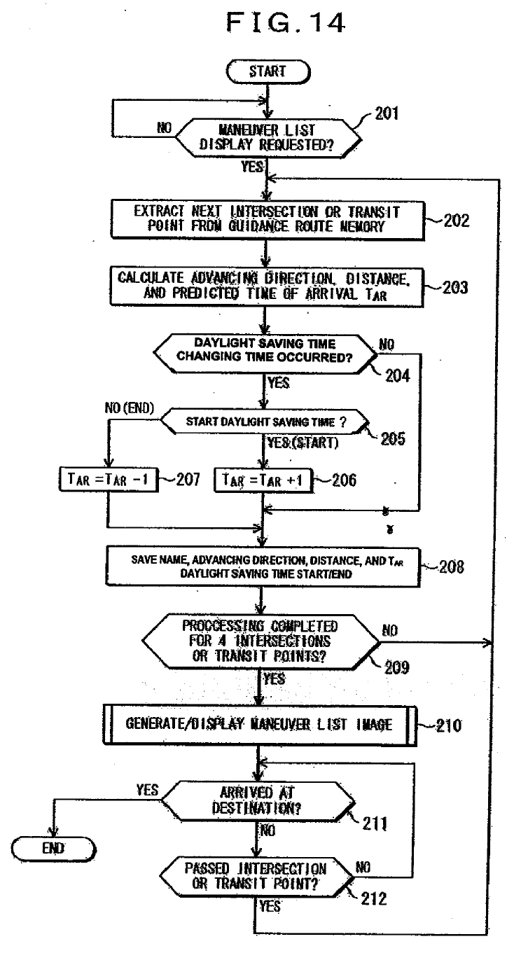

FIG. 14 is a flow chart of a second example of a route guidance process where the displayed time is advanced or delayed by 1 hour based on the start or end of daylight saving time.

Initially, the maneuver list image generating portion 35 monitors whether a maneuver list display was requested by the control portion 22 (step 201). The control portion 22 instructs the maneuver list image generating portion 35 to display the maneuver list display when the maneuver list display is requested by a user operation. The maneuver list image generating portion 35 then extracts the next intersection or transit point ahead of a vehicle position on the guidance route from the guidance route memory 31 based on an instruction received from the control portion 22 (step 202). The control portion 22 then calculates the vehicle advancing direction, the distance to the extracted point, and the predicted arrival time T_{AR} at the extracted point (step 203). Next, the control portion 22 checks whether a daylight saving time start or end time will occur while the vehicle is traveling to the extracted point (step 204). If no change in daylight saving time will occur while the vehicle is traveling to the extracted point, the predicted arrival time T_{AR} is not changed. However, if daylight saving time will start while the vehicle is traveling to the extracted point (step 205), the predicted arrival time T_{AR} is advanced by 1 hour based on the equation T_{AR}=T_{AR}+1 (step 206). If on the other hand, daylight saving time will end while the vehicle is traveling to the extracted point, the predicted arrival time T_{AR} is delayed by 1 hour based on the equation T_{AR}=T_{AR}−1 (step 207).

When the process of calculating the predicted arrival time T_{AR} ends, the maneuver list image generating portion 35 records the extracted point name, the vehicle advancing direction, the distance to the extracted point, the predicted arrival time T_{AR}, and the daylight saving time information (step 208). Next, the maneuver list image generating portion 35 checks whether the above-described process has been completed for all four intersections or transit points (step 209). If the process has not been completed, the control portion 22 repeats steps 202-208 for the next intersection or transit point.

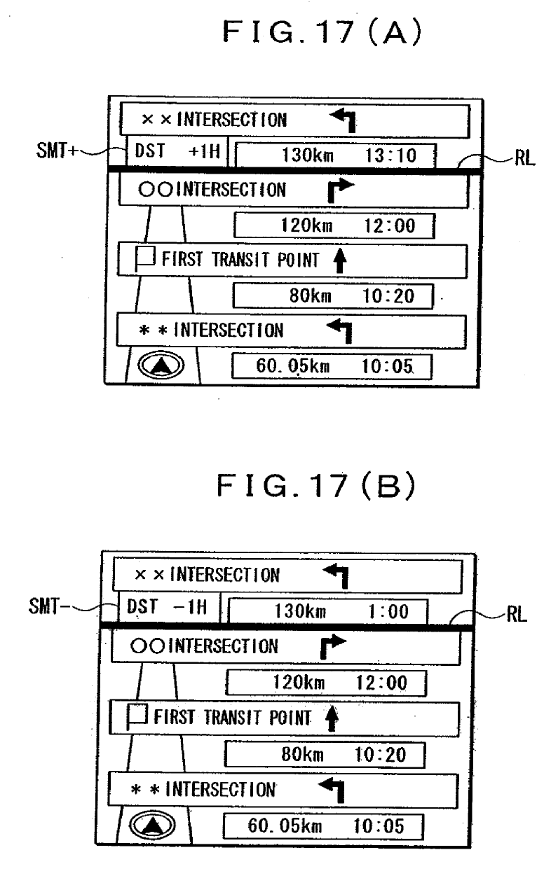

In step 209, when the process ends for the four intersections or transit points, the maneuver list image generating portion 35 creates and displays the maneuver list image (step 210). FIGS. 17(A) and (B) illustrate examples of the maneuver list image for cases including a daylight saving time mark.

Next, the maneuver list image generating portion 35 monitors whether the vehicle has arrived at the destination (step 211). If the vehicle has not reached its destination, the maneuver list image generating portion 35 monitors whether the vehicle has passed the next intersection or transit point (step 212). If the vehicle has passed the next intersection or transit point, the process returns to step 202, and the process is repeated until the vehicle reaches the destination. Thus, the maneuver list image generating portion 35 constantly creates and displays the maneuver list image using the four points closest to the vehicle position on the guidance route, and repeats the above-described process until it arrives at the destination. Of course it should be understood that the maneuver generating portion 35 may display more or less than the four points closest to the vehicle position on the guidance route.

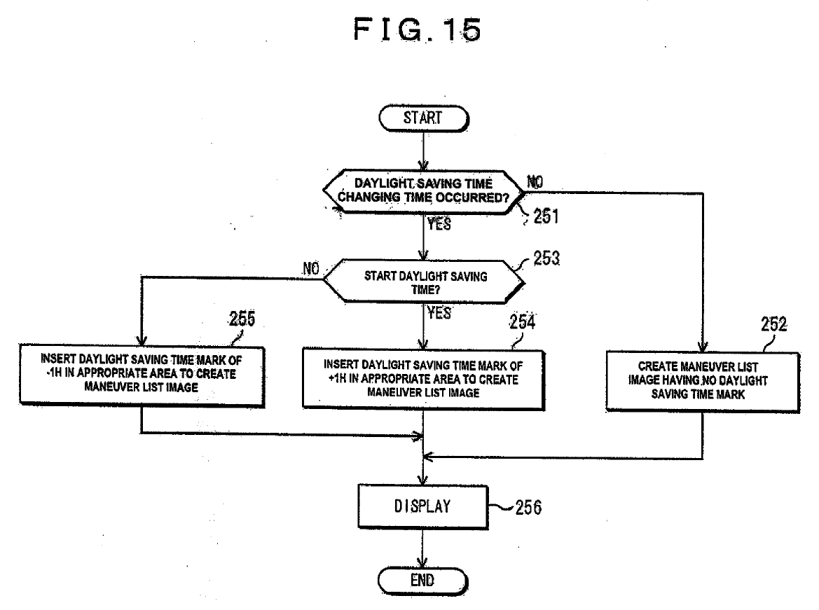

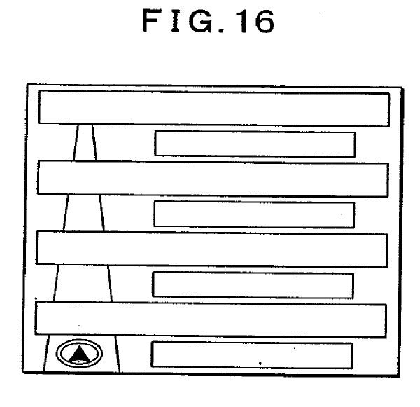

FIG. 15 is a flow chart of the creating and displaying process for the maneuver list image of step 210. The maneuver list image generating portion 35 checks whether the information for the four points includes daylight saving time start/end information (step 251). If no daylight saving time information is included in the information for the four points, the maneuver list image generating portion creates a maneuver list image having no daylight saving time mark (step 252), and the display unit 15 displays the maneuver list image (step 256). The maneuver list image is structured as shown in FIG. 16, and may incorporate characters or reference codes showing predetermined information for points in each frame.

On the other hand, in step 251, if information for one of the four points includes daylight saving time start/end information, the control portion 22 checks whether the daylight saving time start/end information is a daylight saving time start (step 253). If so, a +1 hour of daylight saving time mark SMT+ is added to an appropriate area of a maneuver list image that is similar to the maneuver list image created in step 252 (step 254), and the display unit 15 displays the maneuver list image (step 256). A red line RL may also be added to the maneuver list image to further distinguish the points affected by the time zone difference, as shown in FIG. 17(A). Further, if daylight saving time ends, a -1 hour of daylight saving time mark SMT− is added to an appropriate area of a maneuver list image that is similar to the maneuver list image created in step 252 (step 255), and the display unit 15 displays the maneuver list image (step 256). A red line RAL may also be added to the maneuver list image, as shown in FIG. 17(B).

In the above described process, the time zone mark is displayed to show a change in time display based on the start or end of daylight saving time, but as shown in FIG. 4, the display color of a predicted time of arrival (shown with oblique lines) at a point affected by the start or end of daylight saving time can be displayed in a manner to distinguish it from the display color of the predicted time of arrival at points that were unaffected by the start or end of daylight saving time. Meanwhile, when the predicted time of arrival at all four displayed points become affected by the start/end of daylight saving time, all the displayed points can be shown in the same color they were originally displayed in prior to the startend of daylight saving time.

As described above, according to the route guidance method of the second example, in the case where the start or end of daylight saving time occurs while the vehicle is traveling between two adjacent points, the predicted time of arrival at a point located farther along the guidance path than the vehicle position is displayed in a manner such that a user can recognize that the time was changed due to the start or end of daylight saving time, thus allowing the user to easily discern when time is advanced by a predetermined amount of time or delayed by a predetermined amount of time based on the start or end of daylight saving time. Further, according to the route guidance method of the second example, a daylight saving time advance mark or daylight saving time delay mark is displayed to aid the user in recognizing at a glance when a time display is changed based on daylight saving time. Further, in this embodiment, because the predicted time of arrival at the points affected by the start/end of daylight saving time can be displayed in a different color than the predicted time of arrival at points unaffected by daylight saving time, the user can recognize a change of time display based on the start/end of daylight saving time at a glance.
(E) Third example of route guidance

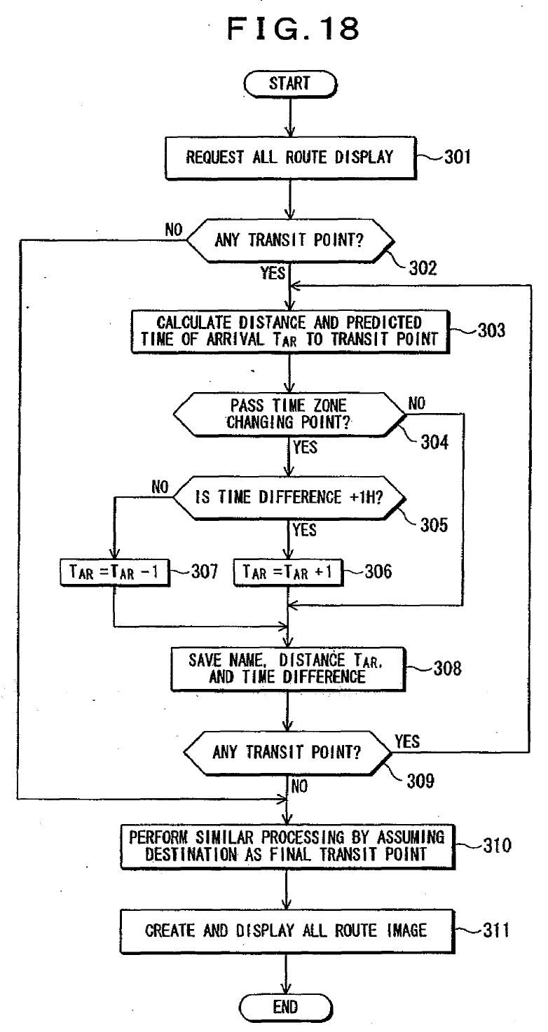

FIG. 18 is a flow chart of a third example of a route guidance process for the guidance route depicting portion 32 in the case where the complete guidance route (complete route) is displayed from the starting point to the destination point, and time is advanced or delayed based on a difference in time zones.

When a complete route display is requested by the control portion 22 (step 301), the guidance route depicting portion 32, checks whether a transit point is present ahead of a subject transit point, which is initially set as the starting point (step 302). If a transit point is present ahead of the subject transit point, the guidance route depicting portion 32 then calculates the distance from the starting point to the transit point and the predicted arrival time T_{AR} (step 303). Next, the guidance route depicting portion 32 checks whether the vehicle passes the time zone changing point Ptc while traveling from the subject transit point to the next transit point (step 304). If the vehicle has not passed the point Ptc, the guidance route depicting portion 32 does not change the predicted arrival time T_{AR} and the process moves to step 308. However, if the vehicle passes the time zone changing point, the guidance route depicting portion 32 checks whether the time zone difference is +1 hour (step 305), and if so, the guidance route depicting portion 32 advances the predicted arrival time T_{AR} by 1 hour based on the equation T_{AR}=T_{AR}+1 (step 306). If the time zone difference is −1 hour, the guidance route depicting portion 32 delays the predicted arrival time T_{AR} by 1 hour based on the equation T_{AR}=T_{AR}−1 (step 307).

After the predicted arrival time TAR process has been completed, the guidance route depicting portion 32 records the transit point name, the distance to the transit point the predicted arrival time T_{AR}, and the time zone information (step 308). Next, the guidance route depicting portion 32 checks whether another transit point is present (step 309), and if so, the process is repeated beginning from step 303 for the next transit point.

If a transit point is not present in step 302 or step 309, a process similar to that shown in steps 303 to 308 is performed using the destination as a final transit point (step 310). When the action of step 310 ends, a flag mark showing a point (transit point, destination), distance to the point, the predicted arrival time T_{AR}, and a guidance route image including a time zone mark are created on the guidance route and displayed on a map (see FIG. 5; step 311), Additionally, the time zone mark TDM+ is added to the predicted time of arrival when the time zone difference is +1 hour (FIG. 5(A)), and the time zone mark TDM− is added to the predicted time of arrival when the time zone difference is −1 hour (FIG. 5(B)).

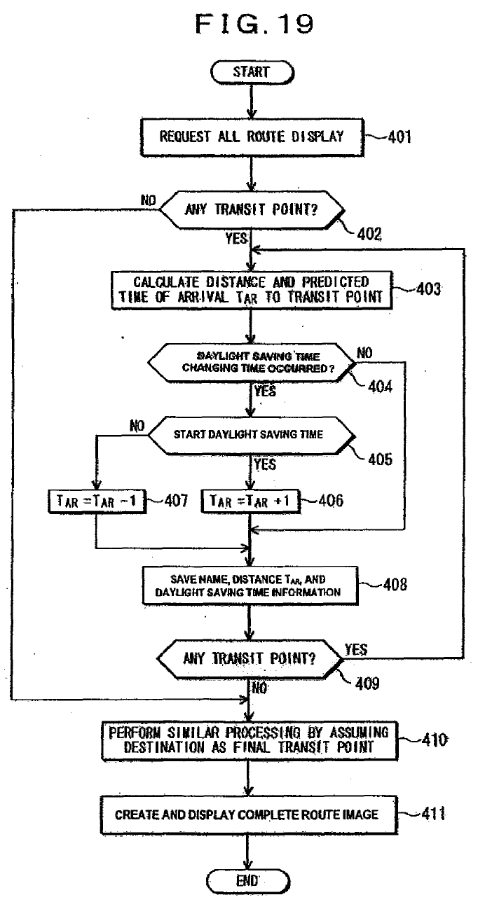

FIG. 19 is a flow chart of a complete route display process in the case where time is advanced or delayed by 1 hour based on the start or end of daylight saving time.

When the complete route display is requested by the control portion 22 (step 401), the guidance route depicting portion 32 checks whether a transit point is present ahead of a subject transit point, which is the starting point at an initial state (step 402). If a next transit point is present, the guidance route depicting portion 32 calculates the distance from the starting point to the next transit point, and the predicted arrival time T_{AR} (step 403). Next, the guidance route depicting portion 32 checks whether the start or end of daylight saving time occurred while the vehicle was traveling from the subject transit point to the next transit point (step 404). If daylight saving time does not start/end while the vehicle is traveling between the subject transit point and the next transit point, the predicted arrival time T_{AR} is left unchanged. However, if daylight saving time does start or end while the vehicle is traveling between the points, the guidance route depicting portion 32 checks whether the daylight saving time started or ended (step 405). If the daylight saving time started, the guidance route depicting portion 32 advances the predicted arrival time T_{AR} by 1 hour based on the equation T_{AR}=T_{AR}+1 (step 406). If the daylight saving time ended, the guidance route depicting portion 32 delays the predicted arrival time T_{AR} by 1 hour based on the equation T_{AR}=T_{AR}−1 (step 407).

After the predicted arrival time T_{AR} calculation process ends, the guidance route depicting portion 32 records the transit point name, the distance to the transit point, the predicted arrival time T_{AR}, and the daylight saving time start/end information (step 408). Next, the guidance route depicting portion 32 portion checks whether another transit point is present (step 409), and if so, the process is repeated beginning from step 403.

If a transit point is not present in step 402 or step 409, a process similar to the one in step 403 through step 408 is performed using the destination as a final transit point (step 410). When the action of step 410 ends, a flag mark showing a point (transit point, destination), distance to the point, the predicted arrival time T_{AR}, and a guidance route image including a daylight saving time mark are created on the guidance route, which is displayed on a map (refer to FIG. 6, step 411). Additionally, the daylight saving time mark SMT+ is added to the predicted time of arrival at a point when daylight saving time starts (FIG. 6(A)), and the daylight saving time mark SMT− is added to the predicted time of arrival at a point when daylight saving time ends (FIG. 6(B)).

According to the third example, a user can easily recognize when the time display is changed based on the start/end of daylight saving time or a change in time zone on a complete route display.

According to embodiments of the present invention, in the case where a time zone changing point is present between two adjacent points, the predicted time of arrival of a point farther along the guidance route from the vehicle position is displayed in a manner such that a user can easily recognize that the time was changed based on a difference in time zone. Thus the user can easily discern when a time display is changed based on time zone difference in a maneuver list display or a complete route display.

In particular, the user can easily discern whether time was advanced or delayed by a predetermined amount of time based on a difference in time zones when the change is displayed in a distinguishing manner on a maneuver list display.

Further, a user can easily discern at a glance the fact that the predicted time of arrival at a point was changed based on a difference in time zone when an advance time zone mark or a delay time zone mark is displayed. Also, the display color of a predicted time of arrival at a point which was changed due to a difference in time zones may be displayed differently from the display color of the predicted time of arrival at points which were not affected by the change in time zone, thus allowing the user to recognize at a glance that the predicted time of arrival has changed based on the time zone.

According to embodiments of the present invention, in the case where daylight saving time starts or ends while the vehicle is traveling between two adjacent points, the predicted time of arrival at a point farther along the guidance route than the vehicle is displayed on a maneuver list display or a complete route display such that it is recognizable to a user that the time was changed based on the start or end of daylight saving time.

In particular, whether time was advanced by a predetermined amount of time or delayed by a predetermined amount of time may be displayed on a maneuver list display in a manner such that a user can easily recognize that the change in time was based on the start or end of daylight saving time. Further, a user can easily recognize at a glance the fact that the predicted time of arrival was changed based on daylight saving time by displaying a daylight saving time advance mark or a daylight saving time delay mark. Also, a user can easily understand when the predicted times of arrival are changed based on the start or end of daylight saving time by displaying them in a different manner or display color than that of the predicted times of arrival that were not changed.

While there has been illustrated and described what is at present contemplated to be preferred embodiments of the present invention, it will be understood by those skilled in the art that various changes and modifications may be made, and equivalents may be substituted for elements thereof without departing from the true scope of the invention. In addition, many modifications may be made to adapt a particular situation to the teachings of the invention without departing from the central scope thereof. Therefore, it is intended that this invention not be limited to the particular embodiments disclosed, but that the invention will include all embodiments falling within the scope of the appended claims.

What is claimed is:

1. A route guidance method of a navigation apparatus that guides a vehicle to a destination along a guidance route, the method comprising:
displaying in order of proximity to a vehicle position, information relating to a plurality of points located on a guidance route between the vehicle position and a destination, wherein the points are intersections or transit points;
displaying a predicted time of arrival at each of the plurality of points along with the information relating to the points;
judging whether a time zone changing point is present between two adjacent points; and
displaying, if the time zone changing point is present, the predicted time of arrival at a point located between the time zone changing point and the destination in a manner such that it is recognizable that a change made to the predicted time of arrival was made based on a time zone difference.

2. The route guidance method according to claim 1, further comprising:
determining whether time should be advanced or delayed by a predetermined amount of time based on the time zone difference, wherein time is displayed in a manner such that it is recognizable that the predicted time of arrival at the point located between the time zone changing point and the destination was advanced or delayed by a predetermined amount of time based on the time zone.

3. The route guidance method according to claim 1, wherein the recognizable manner of displaying the change to the predicted time of arrival at the point located between the time zone changing point and the destination based on the time zone difference comprises displaying an advance time zone mark or a delay time zone mark.

4. The route guidance method according to claim 1, wherein the recognizable manner of displaying the change to the predicted time of arrival at the point located between the time zone changing point and the destination based on the time zone difference comprises displaying a display color of the predicted time of arrival at the point located between the time zone changing point and the destination differently than a display color of the predicted time of arrival at a point located between the vehicle position and the time zone changing point.

5. The route guidance method according to claim 1, further comprising:
searching for a guidance route to a destination and a time zone changing point located on the guidance route in order to generate guidance route information; and
judging whether a time zone changing point is present between two adjacent points on the guidance route using the guidance route information,
wherein information for a plurality of points on the guidance route is displayed using the guidance route information, and the predicted time of arrival at each point is displayed.

6. A route guidance method of a navigation apparatus that guides a vehicle to a destination along a guidance route, the method comprising:
displaying in order of proximity to a vehicle position, information relating to a plurality of points located on a guidance route between the vehicle position and a destination, wherein the points are intersections or transit points;
displaying a predicted time of arrival at each of the plurality of points along with the information relating to the points;
judging whether daylight saving time will start or end while the vehicle is traveling between two points adjacent to each other on the guidance route;
displaying the predicted time of arrival at a point located between the daylight saving time start/end point and the destination in a manner such that it is recognizable that a change in time was made based on the start or end of daylight saving time.

7. The route guidance method according to claim 6, further comprising:
determining whether time should be advanced or delayed by a predetermined amount of time based on the start or end of daylight saving time,
wherein the predicted time of arrival is displayed in a manner such that it is recognizable whether the predicted time of arrival at the point located between the daylight saving time start/end point and the destination is advanced or delayed by the predetermined amount of time based on the start or end of daylight saving time.

8. The route guidance method according to claim 6, wherein the recognizable manner of displaying the change to the predicted time of arrival at the point located between the daylight saving time start/end point and the destination based on the start or end of daylight saving time comprises displaying a daylight saving time advance mark or a daylight saving time delay mark.

9. The route guidance method according to claim 6, wherein the recognizable manner of displaying the change to the predicted time of arrival at the point located between the daylight saving time start/end point and the destination based on the start or end of daylight saving time comprises displaying a display color for the predicted time of arrival at the point located between the daylight saving time start/end point and the destination differently than a display color for the predicted time of arrival at a point located between the vehicle position and the daylight saving time start/end point.

10. A navigation apparatus that guides a vehicle to a destination along a guidance route, the apparatus comprising:
a guidance route searching portion configured to search for a guidance route to a destination in order to generate guidance route information;
a guidance route recording portion configured to record the guidance route information;
an image generating portion configured to extract a plurality of points located ahead of a vehicle position on a guidance route, and displayed in order of proximity to the vehicle position using the guidance route information, and create an image for displaying a predicted time of arrival at each point together with information regarding the each of the plurality of extracted points, wherein the points are intersections or transit points; and
an image display portion configured to display the created image,
wherein the image generating portion checks whether a time zone changing point is present between two extracted points located adjacent to each other on the guidance route, and if the time zone changing point is present, creates an image in a manner such that it is recognizable that a change in the predicted time of arrival at a point of the two adjacent points located between the time zone changing point and the destination was based on the time zone difference.

11. The navigation apparatus according to claim 10, wherein the guidance route searching portion is configured to search for a guidance route and a time zone changing point on the guidance route in order to create guidance route information, and the image generating portion is configured to check whether a time zone changing point is present between the two extracted points located adjacent to each other using the guidance route information.

12. The navigation apparatus according to claim 10, wherein the image generating portion is configured to determine whether time should be advanced or delayed by a predetermined amount of time based on the time zone difference, and create an image in a manner such that it is recognizable that the predicted time of arrival for the point of the two adjacent points located between the time zone changing point and the destination was advanced or delayed by a predetermined amount of time based on the time zone difference.

13. The navigation apparatus according to claim 11, wherein the image generating portion creates an image in a manner such that the change to the predicted time of arrival for the point of the two adjacent points located between the time zone changing point and the destination based on the time zone difference is recognizable by using an advance time zone mark or a delay time zone mark.

14. A navigation apparatus that guides a vehicle to a destination along a guidance route, the apparatus comprising:
a guidance route searching portion configured to search for a guidance route to a destination in order to generate guidance route information;
a guidance route recording portion configured to record the guidance route information;
an image generating portion configured to extract a plurality of intersections or transit points that are located ahead of a vehicle position on the guidance route in order of proximity to the vehicle position using the guidance route information, and create an image used to display the predicted time of arrival at each of the plurality of extracted points together with information regarding each of the plurality of extracted each points; and
an image display portion configured to display the created image,
wherein the image generating portion determines whether daylight saving time starts or ends while the vehicle is traveling between two extracted points located adjacent to each other on the guidance route, and if daylight saving time starts or ends while the vehicle is traveling between the two adjacent points, the image generation portion creates an image in a manner such that it is recognizable that the predicted time of arrival for a point of the two adjacent points located between the daylight saving time start/end point and the destination was based on the start or end of daylight saving time.

15. The navigation apparatus according to claim 14, wherein the image generating portion is configured to determine whether time should be advanced or delayed by a predetermined amount of time based on the start or end of daylight saving time, and create an image in a manner such that it is recognizable that the predicted time of arrival for a point of the two adjacent points located between the daylight saving time start/end point and the destination was advanced or delayed by a predetermined amount of time based on the daylight saving time.

16. A navigation apparatus that guides a vehicle from a starting point to a destination along a guidance route, the apparatus comprising:
a guidance route searching portion configured to search for a guidance route that passes through transit points and terminates at a destination, and a time zone changing point located on the guidance route in order to generate guidance route information;
a guidance route recording portion configured to record the guidance route information;
a guidance route image creating portion configured to create a guidance route image for displaying a guidance route, transit points on the guidance route, and a predicted time of arrival at the transit points on a map using the guidance route information, when a complete guidance route is requested; and
a display portion configured to display the map image by superimposing the guidance route image thereon,
wherein the guidance route image creating portion is configured to check whether a time zone changing point is present between any two adjacent points on the guidance route, and if the time zone changing point is present, create the guidance route image in a manner such that it is recognizable that the predicted time of arrival of a point located between the time zone changing point and the destination was calculated based on the time zone difference.
